(19) United States
(12) Patent Application Publication
(10) Pub. No.: US 2022/0343010 A1
(43) Pub. Date: Oct. 27, 2022

(54) System and Method to enable Shared SaaS Multi-Tenancy using Customer Data Storage, Customer-controlled Data Encryption Keys

(71) Applicants: Khurram Ghafoor, Lexington, MA (US); Alexander Kremer, Lexington, MA (US)

(72) Inventors: Khurram Ghafoor, Lexington, MA (US); Alexander Kremer, Lexington, MA (US)

(21) Appl. No.: 17/760,783

(22) PCT Filed: Sep. 21, 2020
(86) PCT No.: PCT/US20/51781

§ 371 Date: Mar. 16, 2022

Related U.S. Application Data
(60) Provisional application No. 62/903,831, filed on Sep. 21, 2019.

(51) Int. Cl. G06F 21/62; H04L 9/08

(52) U.S. Cl. CPC G06F 21/6218; H04L 9/08

(57) ABSTRACT

A system controls access to data for customer of a multi-tenant software as a service (SaaS) system. A multi-tenant SaaS system cloud includes a metadata store. A customer-controlled storage realm includes a customer-controlled key management system (KMS) and a data store for storing encrypted customer data objects. An agent at a user endpoint identifies customer data for storage in the customer data store, transmits metadata and telemetry information related to the customer data to a SaaS application interface (API), and provides a storage reference for a SaaS metadata store. The agent is pre-configured with credentials from the KMS for storing customer data objects in the data store. The customer-controlled storage realm is not in direct communication with the SaaS system cloud.

### CROSS-REFERENCE TO RELATED APPLICATIONS

This application claims the benefit of U.S. Provisional Patent Application Ser. No. 62/903,831, filed Sep. 21, 2019, entitled “Method to enable Shared SaaS Multi-Tenancy using Customer Data Storage, Customer-controlled Data Encryption Keys,” which is incorporated by reference herein in its entirety.

### FIELD OF THE INVENTION

The present invention relates to data security, and more particularly, is related to management of data encryption keys to access customer-controlled keys and/or storage.

### BACKGROUND OF THE INVENTION

Software as a service (SaaS) providers provide software to customers and typically manage storage of customer data associated with the software. For example, insider threat management solutions store large amounts of customer data and process it in several iterations for intelligent reports, search, and archiving purposes. The data is potentially stored for months or years to satisfy compliance requirements.

FIG. 1 is a schematic diagram of an exemplary distributed implementation of a SaaS system 100. The SaaS System 100 includes a SaaS agent 120 that is resident in a user endpoint (computer) 130, and a SaaS backend 110, which as implemented here is remote from the endpoint 130, for example, in communication with the agent 120 via a wired or wireless communication network such as a local area network, a wide area network, or via the internet, for example, a cloud based server. The agent 120 may be configured to communicate with the operating system 135 of the endpoint 130, for example, the agent 120 may register for notifications from the operating system 135. The agent 120 may communicate data regarding activity of a customer user to the SaaS backend for monitoring and compliance. The SaaS system may store the activity data in a data store 165. The SaaS data store 165 is typically located at remote data centers, for example, in a cloud storage.

The agent 120 may be tailored to communicate with a specific operating system 135 resident on the endpoint 130. For example, the agent 120 may be specific to Windows OS, MacOS, or Unix/Linux, among others. While FIG. 1 shows a single SaaS backend 110, the SaaS backend 110 may be distributed across two or more physical server devices. Likewise, the SaaS data store 165 may be distributed across two or more physical storage devices.

The SaaS agent 120 is installed locally at the endpoint 130. Due to sensitivity of information, most SaaS providers transfer and store customer data in encrypted form. For example, the data transferred from the agent 120 to the SaaS backend 110 may be encrypted, data transferred from the SaaS backend 110 to the agent 120 may be encrypted (TLS/SSL), and data stored in the agent data store 262 and/or the server data store 263 may be encrypted, for example using standard encryption methods like AES protocol or other encryption methods.

Most SaaS providers store the data encryption keys (DEK) used to encrypt the data, for later data retrieval. Data encryption keys (DEK) themselves are usually encrypted using one or more master keys or key encryption keys (KEK). Under some practices the master keys themselves are stored in Key Management Systems (KMS) implemented in software or tamper-resistant hardware (Hardware Security Module-HSM).

Encrypted data is unusable without the data encryption key(s). When stored in encrypted form, data encryption keys are useless without the ability to decrypt them using KEK stored in KMS/HSM.

Throughout the data lifecycle, the SaaS providers may maintain all three aspects of these protection (encrypted data, data encryption keys (DEKs) as well as access to KMS/HSM which encapsulate key encryption keys KEKs). SaaS providers generally have multiple compliance and security controls in place to prevent misuse of the fact that they do possess access to all of the above.

For example, FIG. 2A is a schematic diagram of a prior art system for SaaS provider managed storage and keys. To store customer data in the SaaS data store 165, the SaaS Agent 120 transmits activity data (metadata and binary content, such as screenshot images) to the agent-facing SaaS application interfaces (APIs) 120. The SaaS backend stores the metadata in a metadata store 270 and binary content in designated data store, and a SaaS controlled key management system 265 provides storage credentials (access authorization code) for the SaaS data store 165 to the SaaS agent 120 via the agent-facing SaaS APIs 120. The SaaS Agent 120 transmits the customer data to the SaaS data store 165 using the received storage credentials. The SaaS data store encrypts the customer data using DEK. DEK is then encrypted with KEK and stored appropriately. The SaaS user may likewise access data in the SaaS data store 265 via the user interface 280. The application, such as the user interface 280, queries the SaaS system 100 via externally facing APIs 230, and the SaaS System 100 returns access credentials to the application 380, so the user may then use the credentials (coupled with a data request) to access the stored encrypted data from the SaaS data store 165.

In the above example, the SaaS exclusively manages the encryption keys. Certain customers, however, may not be satisfied with relying only on a SaaS provider's compliance and security controls to prevent unauthorized access to the sometimes highly sensitive, personal, or confidential data they store with the SaaS provider. Therefore, there is a need in the industry to address the abovementioned issue.

### SUMMARY OF THE INVENTION

Embodiments of the present invention provide a method to enable shared SaaS multi-tenancy using customer data storage and customer-controlled data encryption keys. Briefly described, the present invention is directed to a system for controlling access to data for a customer of a multi-tenant software as a service (SaaS) system. A multi-tenant SaaS system cloud includes a metadata store. A customer-controlled storage realm includes a customer-controlled key management system (KMS) and a data store for storing encrypted customer data objects. An agent at a user endpoint identifies customer data for storage in the customer data store, transmits metadata and telemetry information related to the customer data to a SaaS application interface (API), and provides a storage reference for a SaaS metadata store. The agent is pre-configured with credentials from the KMS for storing customer data objects in the data store. The customer-controlled storage realm is not in direct communication with the SaaS system cloud.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic diagram of a prior art SaaS system incorporating a SaaS agent in a user endpoint.

FIG. 2A is a schematic diagram of a prior art system for SaaS provider managed storage and keys.

FIG. 2B is a sequence diagram showing the exchange of messages/data between the elements of FIG. 2A.

FIG. 3A is a schematic diagram of a first exemplary embodiment of a SaaS provider managed storage system with customer-controlled keys (DEK and KEK).

FIG. 3B is a sequence diagram showing an exemplary embodiment of a method for the exchange of messages/data between the elements of FIG. 3A.

FIG. 3C is a schematic diagram of a second exemplary embodiment of a SaaS provider managed storage system with customer-controlled keys.

FIG. 3D is a sequence diagram showing an exemplary embodiment of a method for the exchange of messages/data between the elements of FIG. 3C.

FIG. 4A is a schematic diagram of a third exemplary embodiment of a SaaS system with customer managed storage and customer-controlled keys (DEK and KEK).

FIG. 4B is a sequence diagram showing an exemplary embodiment of a method for the exchange of messages/data between the elements of FIG. 4A.

FIG. 5 is a schematic diagram illustrating an example of a system for executing functionality of the present invention.

### DETAILED DESCRIPTION

The following definitions are useful for interpreting terms applied to features of the embodiments disclosed herein, and are meant only to define elements within the disclosure.

As used within this disclosure, “Software-as-a-Service” (SaaS) refers to a software licensing and delivery model in which software is licensed on a subscription basis and is centrally hosted. It is sometimes referred to as “on-demand software.”

As used within this disclosure, “Data Encryption Keys” (DEK) refers to a sequence of characters used to encrypt and decrypt the data. DEKs are often encrypted themselves with a master key (KEK).

As used within this disclosure, “Key Management Systems (KMS)” stores the master keys

As used within this disclosure, “Key encryption Keys (KEK)” refer to so-called “master keys” that are used to encrypt and decrypt DEKs.

As used within this disclosure, ITM (Insider Threat Management)

As used within this disclosure, a “Hardware Security Module (HSM)” refers to a hardware system that encapsulates the KEK or the master key and provides encryption/decryption of DEKs.

As used within this disclosure, “onboarding” refers to the process of configuring access controls and communication between SaaS system and customer-controlled cryptographic infrastructure (e.g. HSM/KMS) or storage. Onboarding may be performed in a manual or automated way.

As used within this disclosure, “multi-tenancy,” or “multi-tenant SaaS” refers to a single instance of software provided by the SaaS provider and its supporting infrastructure serving multiple customers of the SaaS. Each customer generally shares the software application and also may share a single database or data store.

As used within this disclosure “endpoints” refer to customer workstations and servers.

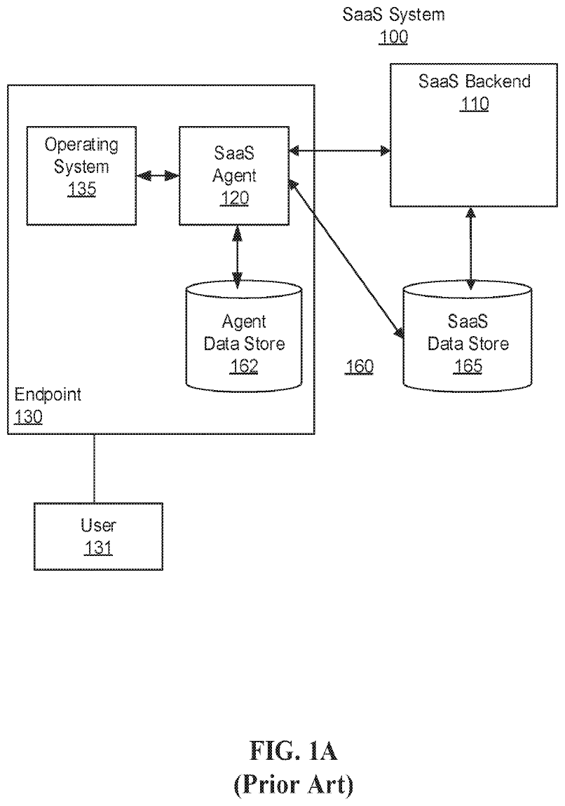

As used within this disclosure, in general, a “user” is a human who interacts with the endpoint (computer) 130 (FIG. 1) described in the embodiments.

As used within this disclosure, “telemetry” refers to the process of monitoring, collecting, and/or analyzing data from a computer and/or system to track user activity in a networked device, for example, to determine inappropriate or potentially harmful access to and/or use of system resources. Telemetry may involve the collection of measurements or other data at remote points (“endpoints”) and their automatic transmission to receiving equipment for monitoring. The telemetry may be collected by an agent installed at the endpoint working in conjunction with the operating system of the endpoint computer/system to monitor user activity such as data usage (bandwidth), file/resource access, internet activity, keystrokes, mouse/keypad movements and clicks, and/or use of external devices (such as USB drives), among others. Telemetry data refers to data (or metadata) collected via or for telemetry. Embodiments of the present invention include a mechanism to onboard and use Customer-controlled Keys (DEK and KEK), storage or both to alleviate the risk of unauthorized access to customer data.

Customer-controlled keys and a customer operated object store enable customers to maintain exclusive control over how their sensitive data is accessed and processed.

In general, the object store is a form of key-value database, enabling applications to store and retrieve data objects (files, images, etc.) of arbitrary size by unique keys.

For sensitive data, the objects in the object store are encrypted using a unique data encryption key (DEK) for each object. Those DEKs are stored and are themselves encrypted using a key encryption key (KEK) usually managed by a Key Management Service or a Hardware Security Module (HSM).

Both KMS and HSM function in a way that enables encryption of small amount of data (such as DEKs) without the master encryption key leaving the KMS or HSM at any time.

The data items that need to be encrypted are sent to a KMS/HSM over an encrypted and authenticated channel. The KMS/HSM at that point encrypts them using internally managed master key and returns the encrypted data to the sender.

Customer-controlled keys and Storage provides ability to the customer to generate and keep control over the encryption keys (data encryption keys and/or master keys) and data at rest, at all times. It allows the customers to effectively give permissions to access, encrypt or decrypt their sensitive SaaS platform data using such encryption keys and solutions e.g. HSM, cloud key management solutions such as Amazon Web Services (AWS) KMS etc. As mentioned above, HSM and KMS facilities operate by encrypting or decrypting data sent to them if the credentials (authorization token) of the sender are valid and allowed to perform encryption and decryption operations.

The embodiments may be implemented, for example, for applications (e.g. user interface) to access to the data via the SaaS solution. Access to the data is predicated on ability to access and decrypt the DEK which in turn is only possible if the SaaS provider or the customer has access to the KEK via the KMS/HSM. The embodiments provide exemplary methods allowing the customer to determine the scope of access to encrypted data by SaaS service provider by controlling access to the DEKs and the KEKs.

Reference will now be made in detail to embodiments of the present invention, examples of which are illustrated in the accompanying drawings. Wherever possible, the same reference numbers are used in the drawings and the description to refer to the same or like parts.

Embodiments of the present invention enable customers to have all the benefits of multi-tenant SaaS, while having full control over their data and/or encryption keys required to access it. With multi-tenancy, customers generally share the software application and also may share a single data store. The embodiments include various mechanisms, described below, to ensure that the data of each tenant is isolated and remains invisible to other tenants.

The embodiments treat different classes of data differently. A first class of data includes sensitive encrypted data, such as user activity screen shots which may be accessed by SaaS services for pre-processing, optical character recognition, and text extraction etc. A second class of data includes data encryption keys (DEK) and master keys (KEK). The first and second classes may be managed directly by customers by using a customer-controlled object store and/or a customer-controlled key management system. The embodiments allow customers using a multi-tenant SaaS solution to onboard their own storage and/or their own keys or both.

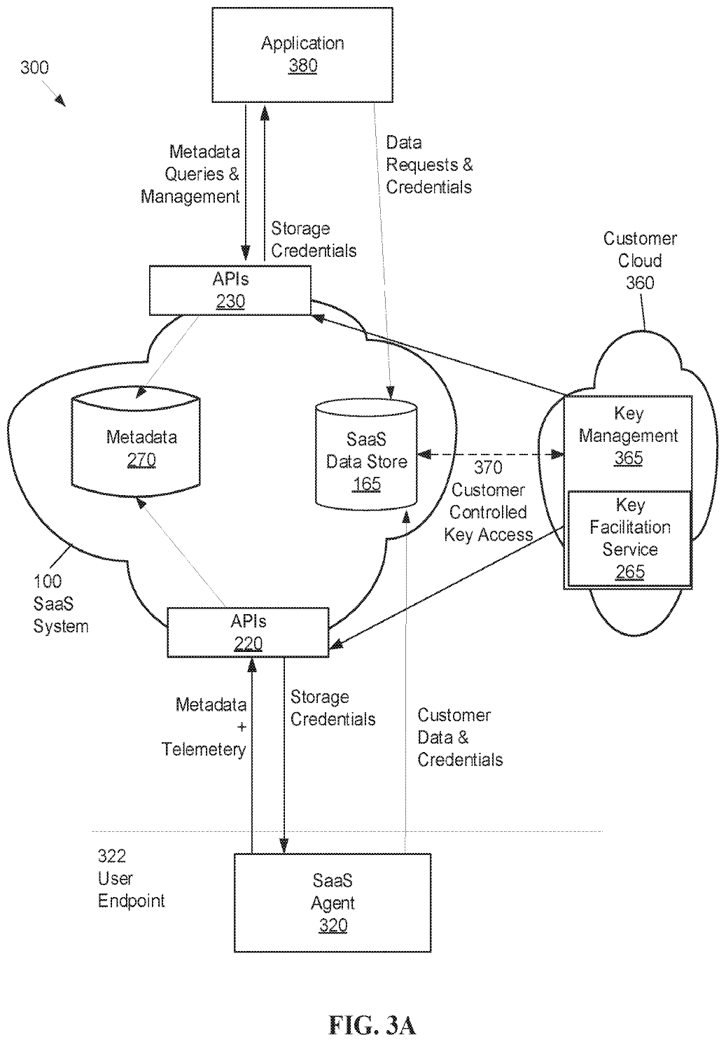

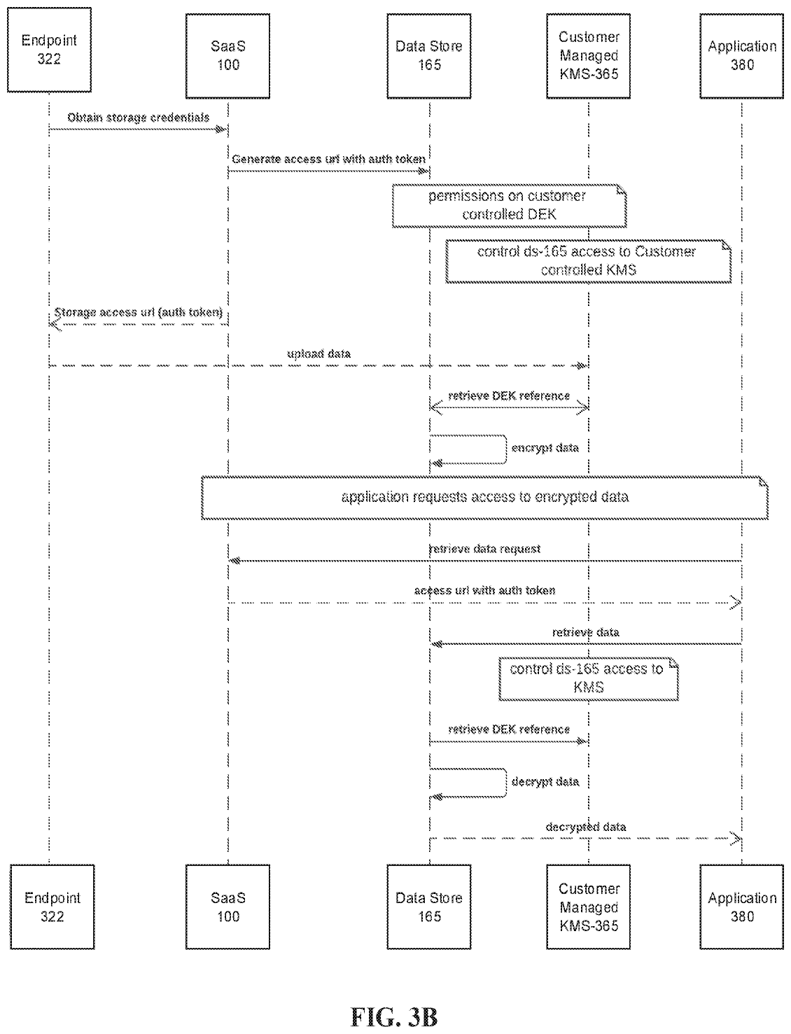

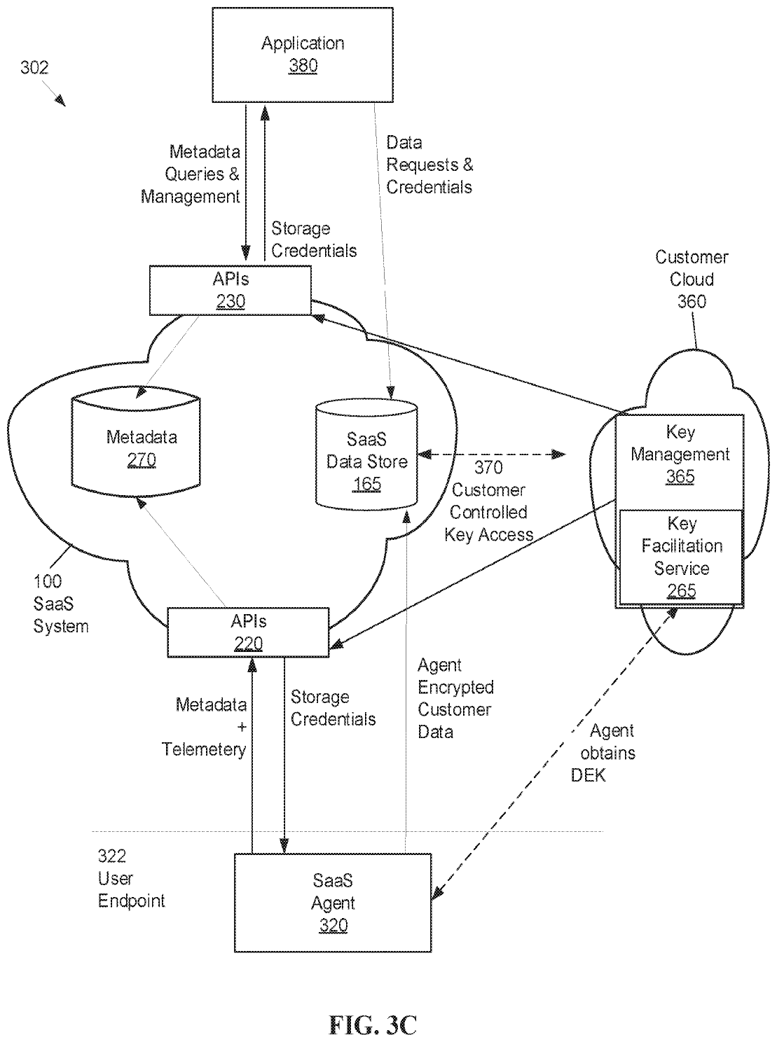

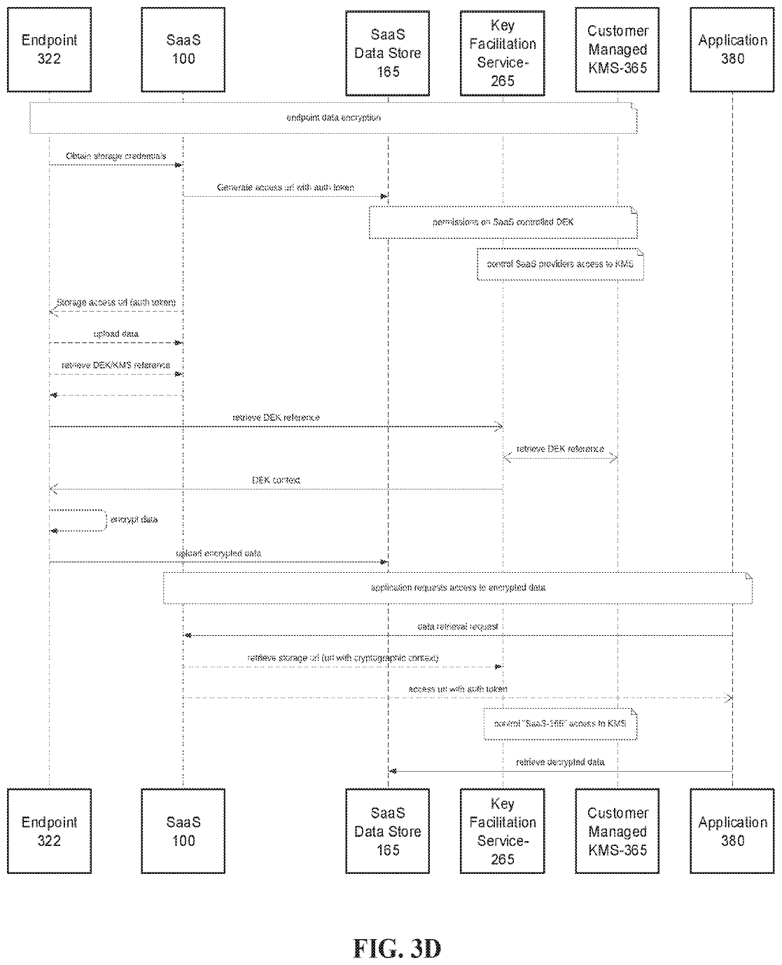

The exemplary embodiments described herein include methods to enable three modalities of customer-controlled access to data. As shown in FIG. 3A, the SaaS agent encrypts data using customer-controlled DEK at endpoint and stores the encrypted data in SaaS provider controlled storage. The SaaS provider backend has no access to the unencrypted data as it does not have access to the DEK. As shown in FIG. 3C, the SaaS agent transmits data to storage controlled by the SaaS provider. The SaaS agent is configured with access to the KEK which is used to encrypt the DEK. The backend of the SaaS provider has access to the stored encrypted data only as long as the customer provides the SaaS backend access to the customer-controlled KEK.

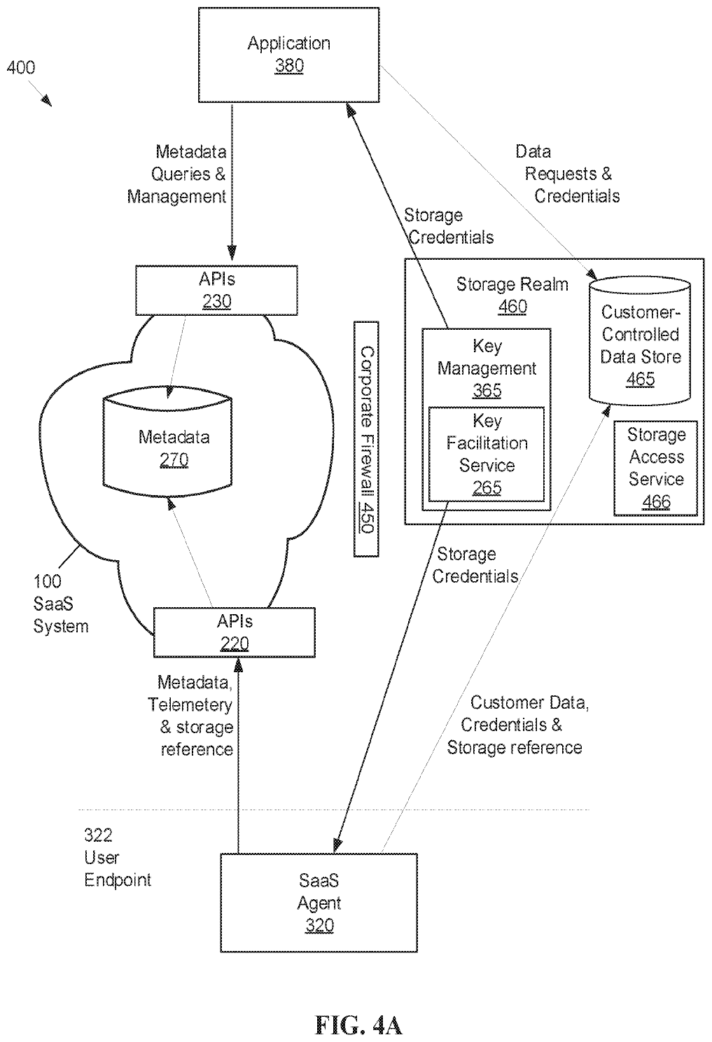

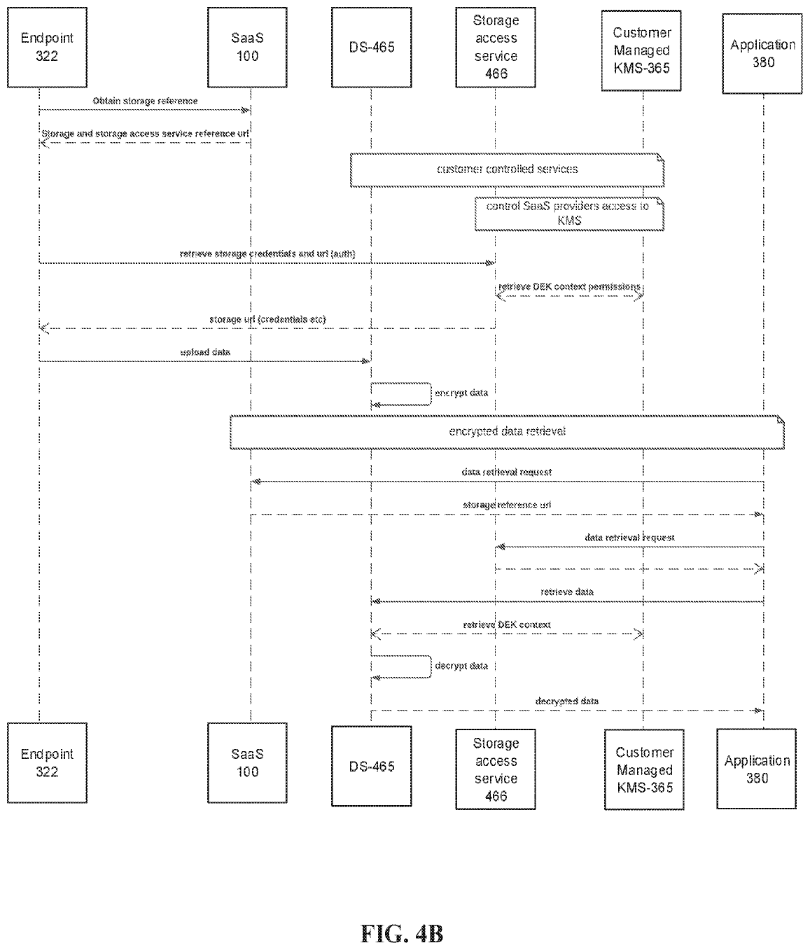

As shown in FIG. 4A, the customer controls both storage and encryption. Here, the SaaS agent is configured to send the data directly to the customer-controlled storage (the SaaS provider has no access to the data at any time). With reference to FIGS. 3A, 3C and 4A, there are several steps involved in the onboarding process for the SaaS system 100. Under the first embodiment shown in FIGS. 3A-3B, the onboarding process for KMS/HSM for each SaaS customer/tenant involves configuring the SaaS backend with limited access to the cryptographic context such as DEK and access to use KEK. The limited access credentials are granted by the customer operating their own KMS/HSM 365. These credentials can be revoked at any time by the customer themselves via customer-controlled key access 370.

In a second embodiment shown in FIGS. 3C-3D, an agent 320 is configured to directly encrypt data before sending it to the SaaS provider data store 165. The agent 320 generally includes the functionality of the agent 120 (FIG. 1), adding additional capabilities described further below. Here, the onboarding process configures the agent 320 with access credentials to the customer-controlled KMS 365. The access credentials allow agents 320 to retrieve DEK and encrypt the data before transmitting it to the SaaS provider data store 165. In such case, for a large deployment of agents 320 on customer endpoints 322 as well as to facilitate retrieval of data by a user application 380) having a user interface. The application 380 may be, for example, a specialized service is provided by the SaaS system 100 to the customer to deploy and operate in the customer-controlled environment. As shown in detail by FIG. 3D, this service facilitates both endpoint agents 320 (for write) and the applications (for read) to obtain appropriate credentials for customer-controlled KMS.

As shown by FIGS. 4A-4B, under a second embodiment, the onboarding process for storage includes configuration of access control and references (e.g. URL) to the external, customer-controlled data store 465. The external customer-controlled data store 465 is used by endpoint agents 320 for accessing the data storage services. The SaaS customer may access data stored in the external customer-controlled data store 465 using an application 380, for example, via a browser application. A URL or reference to the user data is provided by the storage realm 460 as a means for external services to access the storage services in order to write or read a data object. The encryption keys used to encrypt and decrypt the data on customer owned storage is configured directly on such storage service by customers themselves using the customer-controlled KMS/HSM 335 without providing DEK or KEK access to the SaaS system 100.

Access credentials are needed by the agents 320 to transmit the data to customer-controlled storage 165. These credentials can be obtained from the KMS 365 by the agent 320 using one of the following methods:

First, the SaaS service 100 has write only access to the customer-controlled data store 465 and can obtain the access credentials in order to pass them to the agent 320 as part of agent communication and configuration flow.

Second, agents 320 may be directly configured with write only access credentials to the customer-controlled data store 465, in which case, the SaaS service 100 may not have any access at all. In such case, for large deployments of agents 320 on customer endpoints 322 as well as to facilitate retrieval of data by the application 380, a specialized service from the SaaS provider is given to customer to deploy and operate in their customer-controlled storage realm 460. This service facilitates both the agents 320 (for write) and the applications 380 (for read) to obtain appropriate credentials for customer-controlled data store 465. Since in the embodiments shown by FIGS. 3C-D and 4A-B the SaaS provider does not access to the keys and/or storage, the application 380 such as user interface for data retrieval and decryption, signs in with the SaaS provided customer-controlled and operated service to obtain decryption key or access to the customer-controlled storage.

Returning to FIGS. 3A-3D, since the encryption keys and/or the encrypted object store are controlled by the customers, the customers maintain the ability to shut off SaaS provider access to keys at any time via customer-controlled key access 370. Mechanisms for shutting off key access to the SaaS include:
deleting the keys completely, which renders the data unusable forever
revoking the assigned credentials (as explained above), and
changing the permissions for the assigned credentials, for example disallowing decrypt operation explicitly.

Furthermore, if the customer maintains both the storage and the encryption keys, the SaaS provider has no access to the data and encryption key(s) unless the customer explicitly allows such access in order to use SaaS provider's advanced data processing facilities. After such processing, the access can be removed indefinitely.

Customer-controlled keys and Storage provides ability to the customer to generate and keep control over the encryption keys (data encryption keys and/or master keys) and data at rest, at all times. It allows the customers to effectively give permissions to access, encrypt or decrypt their sensitive SaaS data using such encryption keys and solutions e.g. HSM, cloud key management solutions such as AWS KMS etc. As mentioned above, HSM and KMS facilities operate by encrypting or decrypting data sent to them if the credentials of the sender are valid and allowed to perform encryption and decryption operations.

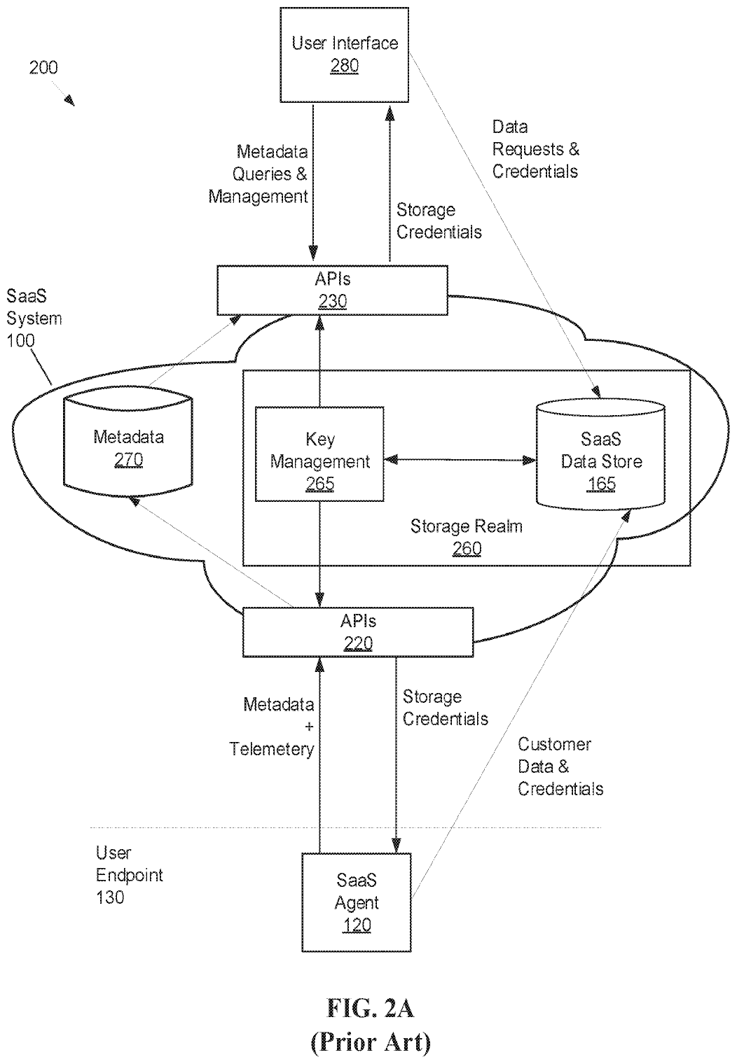

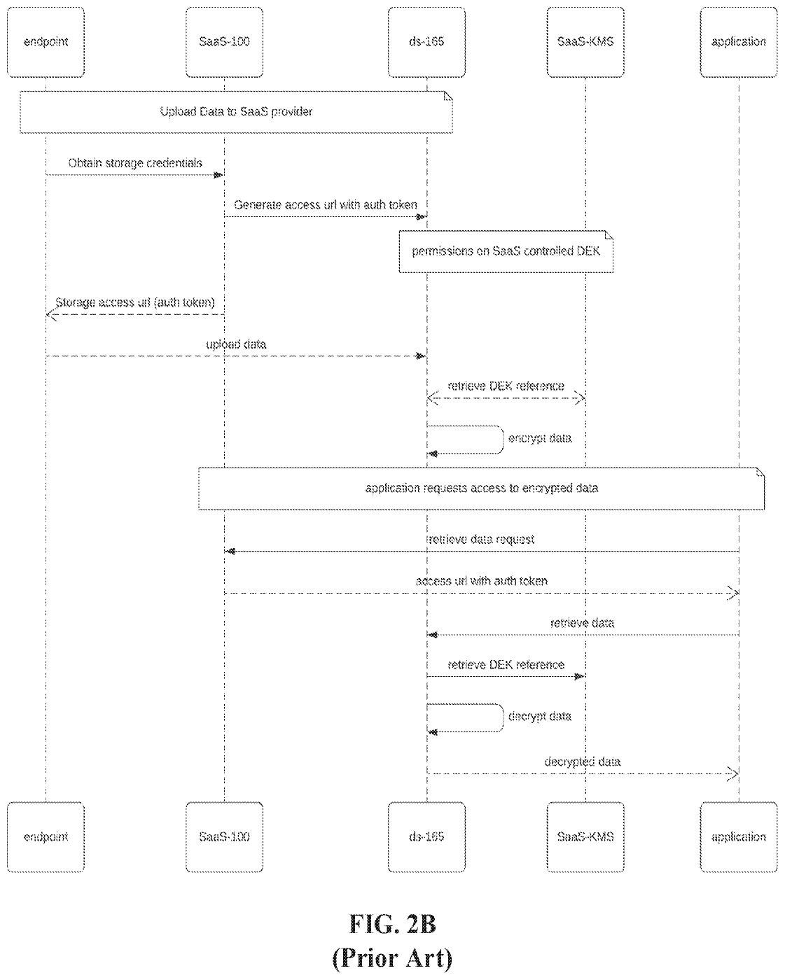

As described in the background section (see FIGS. 2A-B), the SaaS provider 100 may manage both storage and keys. Here, the SaaS customer has no control over access to customer data stored and controlled by the SaaS provider. Under the first exemplary embodiment shown in FIGS. 3A-B, the SaaS provider manages data storage and customer controls the DEK and KEK keys. In this case, the SaaS provider onboards a customer supplied cloud-based key management service 365 (or HSM) and uses the customer supplied cloud-based key management service 365 to encrypt a customer's data stored in the SaaS provider's operated storage. Here, the customer can determine a full audit trail of access to their data since all access in the SaaS provider's storage 165 requires decryption of DEKs using the customer operated KMS/HSM 365. The customer is able to sever all access by the SaaS provider to data of the customer stored in the SaaS data tore 165 at any time.

FIGS. 3A-B depict an exemplary first embodiment where the system 300 includes a multi-tenant SaaS cloud solution 100 that has a metadata store 270, an encrypted data store 165, a SaaS customer facing application interface (API) 230 and an agent (externally) facing API 220. The metadata store 270 references customer data stored in the SaaS data store 165. The metadata store 270 may be used to locate information in the data store 165, whereupon the customer may use the reference to retrieve the corresponding data from the data store 165.

In the first exemplary embodiment, the customer data store 165 is controlled by the SaaS provider. However, the DEK and KEK are controlled by the customer. As part of the onboarding, the SaaS provider configures a reference to the customer-controlled KMS/HSM 365 in order to encrypt and/or decrypt customer data using the customer-controlled DEK. In turn, the customer allows limited (e.g. encrypt only) access to the customer-controlled KMS/HSM by the SaaS provider. After the onboarding, the customer-controlled cloud 360 is in communication with the SaaS system cloud 100. The customer-controlled key management system (KMS) 365 is resident in the customer-controlled cloud 360. For example, the customer-controlled key management system 365 may reside in a KMS server or HSM (not shown) addressable via the customer-controlled cloud 360. At any point in time, the customer may revoke access to the KMS/HSM by the SaaS provider effectively disabling SaaS providers ability to decrypt and access customer data.

A customer endpoint 322, for example, a computer in communication with the SaaS system cloud 100, includes an endpoint processor and an endpoint data store configured to store non-transient instructions that when executed instantiate and maintain a SaaS agent 320 configured to identify customer data for storage in the SaaS encrypted data store 165.

The agent is configured transmit activity metadata and data for storage in the SaaS encrypted data store 165 using externally facing API 220. As the customer data is stored in SaaS provider controlled data store 165, the agent 320 is provided with the access credentials for write-only storage operation by the SaaS providers service 100. Since the customer-controlled keys (DEK and KEK) are configured on the SaaS backend, the agent 320 does not need to communicate with customer-controlled KMS/HSM. The encryption operation is done by the SaaS providers data store 165 instead, using customer-controlled DEK obtained via connection between SaaS provider backend 100 and KMS/HSM controlled by the customer in the customer-controlled cloud 360.

An application 380, such as a user interface for a customer of the SaaS system is in communication with the SaaS system cloud 100, for example, via a wired or wireless communication network. The application 380 enables the user to initiate metadata and management queries to the SaaS user facing API 230 in order to identify the customer data in the SaaS data store 165. For example, the application 380 may provide metadata queries to the user facing API 230, and the user facing API accesses the metadata store 270 using metadata in the query so the metadata store 270 can locate a reference to associated customer data stored in the SaaS data store 165 which is encrypted by the customer-controlled DEK. At this point, the SaaS service 100 provides access reference and credentials (e.g. URL containing access token) to the application 380. The application 380 may thereafter request to retrieve customer data from SaaS data store 165. At this point, the SaaS data store 165 verifies the credentials and then requests to obtain DEK from the customer-controlled KMS/HSM 365. The customer-controlled KMS/HSM 365 then validates that the SaaS data store 165 has access to the DEK key for the purpose of data decryption. If the validation succeeds, the KMS 365 allows the SaaS data store 165 to decrypt the customer data. As a result, the SaaS data store 165 decrypts customer data and returns it to the application 380 via the user facing API 230.

FIG. 3C shows a second exemplary embodiment that is substantially similar to the first embodiment 300, where the system 302 includes a multi-tenant SaaS cloud solution 100 that has a metadata store 270, an encrypted data store 165, a SaaS customer facing application interface (API) 230 and an agent facing API 220. The metadata store 270 references customer data stored in the SaaS data store 165. The metadata store 270 may be used to locate information in data store 165, which may be retrieved from data store 165.

Under the second embodiment 302, the customer data store is controlled by the SaaS provider, and the DEK and KEK are controlled by the customer. In contrast with the first embodiment shown in FIG. 3A, here the SaaS provider service has no access to the customer-controlled DEK at all, as the SaaS provider service does not have access to customer-controlled KMS/HSM 365. Instead the agent 320 deployed on customer endpoint 322 is configured with an access reference and credentials to the customer-controlled KMS/HSM 365 and can obtain the DEK independently from the SaaS providers system 100. As a result, the agent 320 may encrypt the data before transmitting it to the SaaS data store 165. At no point in time, does the SaaS provider has access to the unencrypted customer data stored in SaaS data store 165.

As part of the onboarding, the customer deploys a SaaS provided key facilitation service 265 in the customer-controlled cloud 360. The key facilitation service 265 provides an externally facing API, enabling an authorized endpoint agent 320 to obtain access to the DEK (managed and controlled by customer HSM/KMS 365). The SaaS providers developed agent 320 installed on the customer endpoint 322 is thereby configured not only with the access credentials to the SaaS provider data store 165 but also with credentials to access customer-controlled key facilitation service 265.

For example, on a customer endpoint 322, the agent 320 is in communication with the SaaS system cloud 100 as well as in communication with the customer-controlled key facilitation service 265. When the agent 320 intends to transmit customer data to the SaaS providers data store 165 using the externally facing API 220, the agent 320 first obtains the DEK from the customer-controlled key facilitation service 265. The agent 320 then proceeds to encrypt the data and transmit the encrypted data to SaaS data store 165. Since the customer-controlled keys (DEK) access is configured directly on the agent 320, the SaaS provider 100 does not need to communicate with customer-controlled KMS/HSM 365.

An application 380, such as a user interface for the SaaS system 100, requires an access reference as well as credentials to the customer-controlled key facilitation service. The access referenced is managed by storing the reference to the customer-controlled key facilitation service 265 in the SaaS provider system 100 during the onboarding process. In order to access the data in decrypted form, the application 380 then requests the customer-controlled key facilitation service 265 to issue DEK cryptographic context. The application 380 independently obtains the access reference along with credentials from the SaaS provider 100 to retrieve the encrypted customer data stored in the SaaS data store 165. If both requests by the application 380 are authorized, the access credentials to the encrypted data are issued by the SaaS provider backend 100. Upon retrieving the customer data, the application 380 proceeds to access the decrypted data. In this way, the SaaS provider system 100 does not have direct access to the customer data in unencrypted form at any time.

As shown by FIG. 4A, under a third exemplary embodiment a system 400 for controlling access to data for a multi-tenant SaaS system includes a multi-tenant software as a service (SaaS) system cloud 100 that has a metadata store 270. The metadata store 270 references customer data stored in the customer-controlled data store 465. The metadata store 270 can be used to locate information in customer data store, upon which the retrieval from customer data store is necessary.

A customer-controlled storage realm 460 includes a customer-controlled key management system (KMS) 365 as well as a customer-controlled data store 465 for storing encrypted customer data. Under the third embodiment there is no need for any direct communication between the SaaS system 100 and the KMS 365 and there is no need for direct communication between the SaaS system 100 and the customer-controlled data store 465 (for example, a firewall 450 may be configured to prevent access to the storage realm 460 by the SaaS system cloud 100). This is similar to the second embodiment in which customer-controlled KMS/HSM does not have access allowed for the SaaS provider system 100, however, in the second embodiment, the data is still stored in SaaS provider's data store 165 encrypted with customer-controlled DEK. In contrast to the previous embodiments, the third embodiment gives the customer an absolute control and ownership of their data as well as keys to the data, for example, the DEK.

As part of the onboarding process, the SaaS provider system 100 stores the reference to the customer-controlled data store 465 as well as the reference to the customer-controlled key facilitation service 265. However, in the third embodiment a second SaaS provider developed service, a storage access service 466 is deployed by the customer. The customer configures the storage as well as KMS/HSM for data encryption and decryption independent of the SaaS provider. Here, no direct access is needed for the SaaS provider system 100 to the customer-controlled data store 465 or the KMS/HSM 365.

For example, on a customer endpoint 322, the agent 320 is in communication with, the SaaS system cloud 100, the customer-controlled key facilitation service 265, as well as the customer-controlled storage access service. The agent is configured to obtain the access credentials (write only) to the customer-controlled data store 465 from the customer-controlled storage access service. In addition, the agent 320 obtains a DEK from the customer-controlled key facilitation service 265. At this point the agent 320 proceeds to encrypt customer data using the DEK before transmitting it to the customer-controlled data store 465 using credentials obtained from the storage access service. Alternatively, in cases where the customer-controlled data store supports encryption, the step in which agent encrypts the data may be omitted and instead the customer-controlled data store encrypts the data using the DEK based on the customer-controlled KMS/HSM 365.

An application 380, such as a user interface for the SaaS system 100 requires access reference as well as credentials to the customer-controlled data store. The application 380 obtains the reference to the customer-controlled storage access service 466 as well as to the customer-controlled key facilitation service 265 from the SaaS system 100. The application 380 then proceeds to independently authenticate with both services 265, 466 using credentials configured entirely by the customer. Once authenticated, the application 380 may request access to customer data stored in a customer-controlled data store 465 using the customer-controlled storage access service 466 as well as to the DEK using the customer-controlled key facilitation service 265. The application 380 requests customer data from the customer-controlled data store 465 using credentials obtained from storage access service 466. The customer-controlled data store 465 verifies the credentials and transmits the data to the application 380. The application then proceeds to decrypt the data using the DEK obtained from customer-controlled key facilitation service 265.

In this embodiment SaaS provider service 100 has no access to either the encrypted customer data (as it is stored in customer-controlled data store 465) and it has no access to DEK information for any of the data stored there.

Overall, to enable agents 320 writing data to customer operated storage, agents 320 must be preconfigured with access credentials to storage key management so they can obtain credentials to write to the customer operated storage.

To enable access to customer operated storage via the application 380, for example, a web application, the web application 380 is pre-configured with credentials to storage key management 365. This is a prerequisite for any access to customer-controlled data store 465.

In some implementations, one or more of the following advantages may be present.

1. SaaS customers maintain absolute control over encryption keys as well as master encryption keys

2. SaaS customers can shut off access by the SaaS provider at any time without prior notice

3. SaaS customers can maintain life cycle and access policies of the KMS keys without ITM SaaS provider

4. SaaS customers have 100% control over the data lifecycle e.g. object store lifecycle management

5. SaaS customers control data destruction in the event of purge by removing encryption key or master key access

6. The SaaS customer has Complete or partial data access restriction in the event of a security breach or other critical issues.

7. Through access to KMS, customer can maintain an audit of all grants to access data encryption keys which usually corresponds to access to data by SaaS provider on their behalf. Thus, it can be used to detect discrepancies, which may be due to SaaS provider's unauthorized access to the data.

In an exemplary scenario, the SaaS has a user endpoint agent installed, for example, to capture a screenshot at the endpoint terminal. The agent conveys the encrypted screenshot to the SaaS storage server, where the encryption key DEK is protected by the KEK. The user can turn on/off access for the KMS (key management system) to the SaaS, so that the SaaS can only access the screenshot when the user provides the KMS access to the SaaS. Data stored by the SaaS is always encrypted.

A customer can grant the SaaS two levels of access:
Encrypt and decrypt, or
Encrypt only.

Note that even while the endpoint agent 320 is part of the SaaS, and the endpoint agent 320 uses the DEK to encrypt the collected data, the SaaS can only access its received/stored data when permitted by the user. So only the sender/receiver can access the data: access by the service provider is controlled by the user of the SaaS.

For the three embodiments described above:
1. A SaaS agent encrypts data using customer-controlled DEK at endpoint and stores it in SaaS provider controlled storage (SaaS provider backend has no access to the unencrypted data as it does not have access to the DEK), and
2. The SaaS agent transmits data to the SaaS provider's controlled storage, configured with access to KEK which is used to encrypt DEK (SaaS providers backend only has access to data as long customer-controlled KEK is accessible to it
3. The customer controls both storage and encryption, in which case the SaaS agent is configured to send the data directly to the customer-controlled storage (SaaS provider has no access to the data at any time)

It should be noted that any process descriptions or blocks in FIGS. 3B, 3D, and 4B should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

The embodiments described above improve on the functionality of existing SaaS as the provide a customer of a multi-tenant SaaS a system and method for controlling access to data the customer wishes to remain private, whereas previously the customer had provided access to the private data and rely on the SaaS provider to maintain appropriate security.

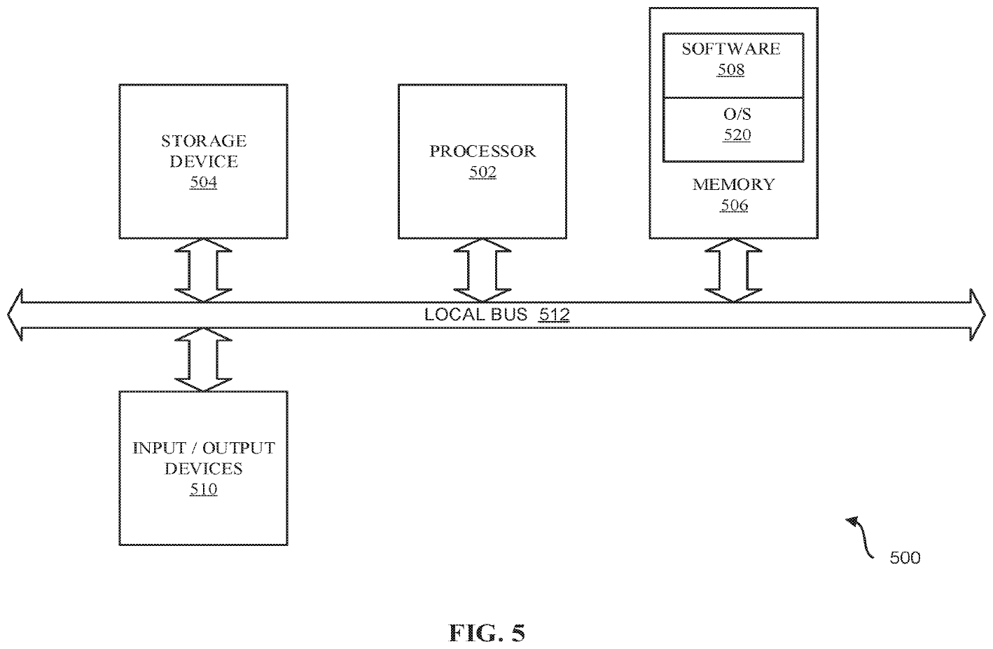

The present system for executing the functionality described in detail above may be a computer, an example of which is shown in the schematic diagram of FIG. 5. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 and the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

A number of embodiments of the invention have been described. Nevertheless, it will be understood that various modifications may be made without departing from the spirit and scope of the invention.

Any processor(s), or the like, described herein or otherwise present in the system(s) described, can be implemented as one or more than one processor. If implemented as more than one processor, the processors can be located in one facility (e.g., in the building or campus of the hotel) or distributed across multiple locations. Likewise, any memory described herein, or otherwise present in the system(s) described, can be implemented as one or more than one memory device. If implemented as more than one memory device, the memory devices can be located in one facility or distributed across multiple locations.

Various aspects of the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to include a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Certain operations described in this specification can be implemented as operations performed by a data processing apparatus (e.g., a processor) on data stored on one or more computer-readable storage devices or received from other sources. The term “processor” (or the like) encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations may be described herein as occurring in a particular order or manner, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer based system for controlling access to data for a customer of a multi-tenant software as a service (SaaS) system comprising:
a multi-tenant software as a service (SaaS) system cloud further comprising:
a metadata store;
an encrypted data store;
a SaaS user facing application interface (API); and
an agent facing API;
a customer-controlled cloud in communication with the SaaS system cloud comprising a key management system (KMS);
a user endpoint in communication with the SaaS system cloud further comprising:
an endpoint processor and an endpoint data store configured to store non-transient instructions that when executed operate a SaaS agent configured to perform the steps of:
identifying customer data for storage in the SaaS encrypted data store;
transmitting metadata and telemetry information related to the customer data to the agent facing API;
receiving storage credentials from the KMS via the agent facing API; and
storing the customer data in the SaaS encrypted data store using the received storage credentials,
wherein the KMS is configured to controllably enable key access to the SaaS system cloud.

2. The system of claim 1, further comprising:
an application in communication with the SaaS system cloud configured to:
provide metadata and management queries to the SaaS user facing API to identify the customer data;
receive the storage credentials from the KMS via the customer facing API; and
access the customer data in the SaaS encrypted data store using the received storage credentials.

3. The system of claim 1, further comprising a key facilitation service configured to provides storage credentials for the SaaS data store 165 to the SaaS agent via the agent-facing SaaS APIs.

4. A computer based system for controlling access to data for a customer of a multi-tenant software as a service (SaaS) system comprising:
a multi-tenant software as a service (SaaS) system cloud, further comprising:
a metadata store;
a SaaS customer facing application interface (API); and
an agent facing API;
a customer-controlled storage realm, further comprising:
a customer-controlled key management system (KMS); and
a customer-controlled data store for storing encrypted customer data objects;
a user endpoint, in communication with the SaaS system cloud comprising an endpoint processor and an endpoint data store configured to store non-transient instructions that when executed instantiate and maintain a SaaS agent configured to perform the steps of:
identifying customer data for storage in the customer-controlled data store;
transmitting metadata and telemetry information related to the customer data to the agent facing API; and
providing a storage reference for the metadata store associated with the metadata;
wherein the agent is pre-configured with credentials from the KMS for storing customer data objects in the customer-controlled data store, and the customer-controlled storage realm is not in direct communication with the SaaS system cloud.

5. The system of claim 4, further comprising:
an application in communication with the SaaS system cloud pre-configured with storage credentials to the storage key management, configured to:
provide metadata and management queries to the SaaS user facing API to identify the customer data in the image store object;
receive a reference to the customer data in the image storage object from the user facing API; and
access the customer data in the customer-controlled data store using the received reference and the pre-configured storage credentials.

6. The system of claim 4, further comprising a firewall configured to prevent access to the storage realm by the SaaS system cloud.

7. The system of claim 5, further comprising a key facilitation service configured to provides storage credentials for the data store to the SaaS agent via the agent-facing SaaS APIs.

8. The system of claim 7, further comprising a storage access service in communication with the key facilitation service and the KMS configured to provide a data reference to data in the data store to the agent and/or the application.

9. A computer based method for controlling access to data for a customer of a multi-tenant software as a service (SaaS) system comprising a metadata store, an encrypted data store, a SaaS user facing application interface (API), and an agent facing API via a customer cloud in communication with the SaaS system cloud comprising a key management system (KMS), a user endpoint in communication with the SaaS system cloud, comprising the steps of:
identifying customer data for storage in the SaaS encrypted data store;
transmitting metadata and telemetry information related to the customer data to the agent facing API;
receiving storage credentials from the KMS via the agent facing API; and
storing the customer data in the SaaS encrypted data store using the received storage credentials.

10. The method of claim 9, further comprising the step of the KMS controllably enabling key access to the SaaS system cloud.

11. The method of claim 10, further comprising the steps of:
by an application in communication with the SaaS system cloud, performing metadata and management queries to the SaaS user facing API to identify the customer data;
receiving the storage credentials from the KMS via the customer facing API; and
accessing the customer data in the SaaS encrypted data store using the received storage credentials.

12. The method of claim 10, further comprising the step of:
by a key facilitation service, providing storage credentials for the SaaS data store to the SaaS agent via the agent-facing SaaS APIs.

13. A computer based method for controlling access to data for a customer of a multi-tenant software as a service (SaaS) system cloud further comprising a metadata store, a SaaS user facing application interface (API), and an agent facing API, a customer storage realm further comprising a customer-controlled key management system (KMS) and an a customer-controlled data store for storing encrypted customer data objects, and a user endpoint, in communication with the SaaS system cloud comprising the steps of:
identifying customer data for storage in the customer-controlled data store;
transmitting metadata and telemetry information related to the customer data to the agent facing API; and
providing a storage reference for the metadata store associated with the metadata,
wherein the customer-controlled storage realm is not in direct communication with the SaaS system cloud.

14. The method of claim 13, further comprising the step of:
pre-configuring the agent with credentials from the KMS for storing customer data objects in the customer-controlled data store.

15. The method of claim 13, further comprising the steps of:
pre-configuring an application in communication with the SaaS system cloud with storage credentials to the storage key management;
providing metadata and management queries to the SaaS user facing API to identify the customer data in the image store object;
receiving a reference to the customer data in the image storage object from the user facing API; and
accessing the customer data in the customer-controlled data store using the received reference and the pre-configured storage credentials.

16. The method of claim 13, further comprising the step of providing a firewall configured to prevent access to the storage realm by the SaaS system cloud.

17. The method of claim 14, further comprising the step of providing by a key facilitation service storage credentials for the data store to the SaaS agent via the agent-facing SaaS APIs.

18. The method of claim 17, further comprising the step of providing by a storage access service in communication with the key facilitation service and the KMS a data reference to data in the data store to the agent and/or the application.
